(19) United States
(12) Patent Application Publication
(10) Pub. No.: US 2016/0147007 A1
(43) Pub. Date: May 26, 2016

(54) EMBOSSED FRONTLIGHT SYSTEMS AND METHODS OF FORMING SAME

(71) Applicant: QUALCOMM MEMS Technologies, Inc., San Diego, CA (US)

(72) Inventors: John Hyunchul Hong, San Clemente, CA (US); Jian Ma, Carlsbad, CA (US); Tallis Young Chang, San Diego, CA (US)

(21) Appl. No.: 14/554,561

(22) Filed: Nov. 26, 2014

(51) Int. Cl. F21V 8/00; G09G 5/00

(52) U.S. Cl. CPC G02B 6/0055; G09G 5/003; G09G 2370/08

(57) ABSTRACT

This disclosure provides systems, methods and apparatus for forming light-guiding layers including embossed light-turning features. In one aspect, an aluminized polymer layer can be embossed onto a light-transmissive layer having a high index of refraction to form the light-guiding layer. In another aspect, the light-guiding layers may be formed using a mold that has positive relief features and features which mechanically separate a portion of an embossed reflective layer from surrounding portions of the embossed reflective layer to form light-turning features.

### TECHNICAL FIELD

This disclosure relates to frontlight systems, and in particular frontlight systems which can be used alone or in conjunction with reflective displays.

### DESCRIPTION OF THE RELATED TECHNOLOGY

Electromechanical systems (EMS) include devices having electrical and mechanical elements, actuators, transducers, sensors, optical components such as mirrors and optical films, and electronics. EMS devices or elements can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, and/or other micromachining processes that etch away parts of substrates and/or deposited material layers, or that add layers to form electrical and electromechanical devices.

### SUMMARY

The systems, methods and devices of this disclosure each have several innovative aspects, no single one of which is solely responsible for the desirable attributes disclosed herein.

One innovative aspect of the subject matter described in this disclosure can be implemented in a mold for use in forming an embossed light-turning film, the mold including a generally planar lower surface, a plurality of raised embossing features extending from the lower surface of the mold, where the plurality of raised features include an angled sidewall oriented at an angle to the lower surface of the mold, and a plurality of raised cutting features extending from the lower surface of the mold, where each of the plurality of raised embossing features is surrounded by a raised cutting feature.

In some implementations, the plurality of raised embossing features can be frustoconical in shape. In some implementations, the plurality of raised embossing features can be radially symmetric. In some implementations, the angle between the sidewall and the lower surface of the mold can be between 55° and 59°.

In some implementations, the surfaces of the raised embossing features can be configured to be less adhesive than the generally planar lower surface of the mold. In some implementations, the raised embossing features or the surfaces of the raised embossing features can be coated with polytetrafluoroethylene.

Another innovative aspect of the subject matter described in this disclosure can be implemented in a method of fabricating a light-turning film. The method includes bringing a reflective layer into contact with a deformable transparent layer to form a multilayer structure, embossing the multilayer structure from the opposite side of the reflective layer as the deformable transparent layer to form depressions in the multilayer structure and to form a plurality of light-turning features from separate portions of the reflective layer adjacent the depressions in the deformable layer.

In some implementations, forming a plurality of light turning features can include mechanically separating portions of the reflective layer adjacent the depressions in the deformable layer from the surrounding portions of the reflective layer, and removing the surrounding portions of the reflective layer to form the plurality of light-turning features.

In some implementations, the reflective layer can include a masking sublayer and a reflective sublayer, and the masking sublayer can be disposed on the opposite side of the deformable transparent layer when the reflective layer is brought into contact with a deformable transparent layer. In some implementations, the multilayer structure can be embossed using a mold, the mold including a plurality of raised embossing features which include an angled sidewall oriented at an angle to the lower surface of the mold, and at least one feature which mechanically separates portions of the reflective layer adjacent the depressions in the deformable layer from the surrounding portions of the reflective layer. In some further implementations, the at least one feature which mechanically separates portions of the reflective layer adjacent the depressions in the deformable layer from the surrounding portions of the reflective layer can include a plurality of raised cutting features extending from the lower surface of the mold, where each of the plurality of raised embossing features is surrounded by a raised cutting feature.

In some implementations, the deformable transparent layer can include a thermoset plastic. In some implementations, the method can include heating the deformable transparent layer to a temperature near a glass transition temperature prior to embossing the multilayer structure.

Another innovative aspect of the subject matter described in this disclosure can be implemented in a mold for use in forming an embossed light-turning film. The mold includes a generally planar lower surface, a plurality of raised embossing features extending from the lower surface of the mold, where the plurality of raised features include an angled sidewall oriented at an angle to the lower surface of the mold, and means for mechanically separating a portion of an embossed layer from a surrounding portion of an embossed layer.

In some implementations, the mechanically separating means can include a plurality of raised cutting features extending from the lower surface of the mold, where each of the plurality of raised embossing features is surrounded by a raised cutting feature. In some implementations, the mechanically separating means can include one or more sections of the generally planar lower surface of the mold which are configured to be more adhesive than the surfaces of the raised embossing feature.

Another innovative aspect of the subject matter described in this disclosure can be implemented in a device including a light-guiding layer. The light-guiding layer can be implemented to constrain light propagating therein. The light-guiding layer includes a plurality of depressions embossed in a first surface of the light-guiding layer, and a plurality of light-turning features disposed within the depressions in the first-surface of the light-guiding layer, where the light-turning features do not extend laterally beyond the edges of the depressions in the light-guiding layer and over a substantially planar portion of the first surface of the light-guiding layer.

In some implementations, the light-turning features can include an angled sidewall oriented at an angle to the first surface of the light-guiding layer and capable of turning light propagating within the light-guiding layer out of the light-guiding layer. In some implementations, the device can additionally include a first cladding layer and a second cladding layer formed from a material having a lower index of refraction than the material of the light-guiding layer, where the light-guiding layer and the plurality of light-turning features are disposed between the first cladding layer and the second cladding layer. In some implementations, the device can additionally include a reflective display disposed on the opposite side of the light-guiding layer as the plurality of light-turning features.

Details of one or more implementations of the subject matter described in this disclosure are set forth in the accompanying drawings and the description below. Although the examples provided in this disclosure are primarily described in terms of EMS and MEMS-based displays the concepts provided herein may apply to other types of displays such as liquid crystal displays (LCD), organic light-emitting diode (OLED) displays, and field emission displays. Other features, aspects, and advantages will become apparent from the description, the drawings and the claims. Note that the relative dimensions of the following figures may not be drawn to scale.

### BRIEF DESCRIPTION OF THE DRAWINGS

FIG. 1A shows a side cross-section of an example of a frontlight system configured to turn incident light out of plane of the device.

FIG. 1B shows a side cross-section of the example frontlight system of FIG. 1A surrounded by cladding layers.

FIG. 2 is a detailed cross-sectional view of an example light-turning feature formed over a depression within a light-guiding layer.

FIG. 3 shows a side cross-sectional view of an example stamping mold which can be used to mechanically define a light-turning feature.

FIGS. 4A-4D illustrate various stages in an example fabrication process for forming a multilayer structure including embossed light-turning features.

FIG. 5 is a side-cross sectional view of another example of a multilayer structure including light-turning features.

FIG. 6 is a flow diagram illustrating an example fabrication process for a multilayer structure including light-turning features mechanically defined by an embossing process.

FIG. 7 is a cross-sectional view of an example display device including a frontlight system which includes light-turning features mechanically defined by an embossing process.

FIG. 8 is an isometric view illustration depicting two adjacent interferometric modulator (IMOD) display elements in a series or array of display elements of an IMOD display device.

FIGS. 9A and 9B are system block diagrams illustrating a display device that includes a plurality of IMOD display elements.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device, apparatus, or system that can be configured to display an image, whether in motion (such as video) or stationary (such as still images), and whether textual, graphical or pictorial. More particularly, it is contemplated that the described implementations may be included in or associated with a variety of electronic devices such as, but not limited to: mobile telephones, multimedia Internet enabled cellular telephones, mobile television receivers, wireless devices, smartphones, Bluetooth® devices, personal data assistants (PDAs), wireless electronic mail receivers, hand-held or portable computers, netbooks, notebooks, smartbooks, tablets, printers, copiers, scanners, facsimile devices, global positioning system (GPS) receivers/navigators, cameras, digital media players (such as MP3 players), camcorders, game consoles, wrist watches, clocks, calculators, television monitors, flat panel displays, electronic reading devices (such as e-readers), computer monitors, auto displays (including odometer and speedometer displays, etc.), cockpit controls and/or displays, camera view displays (such as the display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (such as in electromechanical systems (EMS) applications including microelectromechanical systems (MEMS) applications, as well as non-EMS applications), aesthetic structures (such as display of images on a piece of jewelry or clothing) and a variety of EMS devices. The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes and electronic test equipment. Thus, the teachings are not intended to be limited to the implementations depicted solely in the Figures, but instead have wide applicability as will be readily apparent to one having ordinary skill in the art.

In order to illuminate a reflective display or other object, a frontlight film can be disposed over the object to be illuminated. Light can be injected from the side of the frontlight structure and into a light-turning film. The light can propagate within the light-turning film until it strikes a light-turning feature and is reflected downward and out of the light-turning film to illuminate the underlying object. In some implementations, the light-turning features may include angled surfaces with a reflective coating. When the reflective coatings are lithographically defined, it can be difficult to ensure alignment between the angled surfaces and the lithographically-defined reflective coating. In some implementations, the reflective coating may be patterned so that a section of the reflective coating larger than the angled surface remains, in order to compensate for any deviation from the expected positioning of the reflective coating. However, larger sections of the reflective coating may have a greater impact on the appearance of the display or other object to be illuminated, even when the reflective coating is masked on the opposite side. By forming the reflective coating at the same time as the angled surface through the use of an embossing or stamping process, precise alignment between the reflective coating and the angled surface can be provided.

Particular implementations of the subject matter described in this disclosure can be implemented to realize one or more of the following potential advantages. The embossing or stamping process can be used with a low-cost plastic film. Because light-turning features also can be stamped or embossed, a frontlight structure including precisely arranged reflective surfaces can be formed using inexpensive roll-to-roll fabrication processes. Because the angled surfaces and reflective coatings can be mechanically defined, expensive and complex patterning and etching processes are not required.

A reflective layer of a light turning feature also can have a strongly light absorbing layer on its opposite side, so as to reduce scattering and reflective problems for the viewer which can occur when all or a portion of the reflective layer is visible. Misalignment of these two layers would directly lead to deleterious effects on the reflective viewing properties when portions of the reflective layer are left uncovered by the exposed to a viewer, as well as a decrease in the efficiency of the frontlight when the light absorbing layer extends beyond the reflective layer. The self-alignment feature enabled by mechanically defining the light-turning features can ensure that the opaque and reflective sides are substantially aligned.

An example of a suitable EMS or MEMS device or apparatus, to which the described implementations may apply, is a reflective display device. Reflective display devices can incorporate interferometric modulator (IMOD) display elements that can be implemented to selectively absorb and/or reflect light incident thereon using principles of optical interference. IMOD display elements can include a partial optical absorber, a reflector that is movable with respect to the absorber, and an optical resonant cavity defined between the absorber and the reflector. In some implementations, the reflector can be moved to two or more different positions, which can change the size of the optical resonant cavity and thereby affect the reflectance of the IMOD. The reflectance spectra of IMOD display elements can create fairly broad spectral bands that can be shifted across the visible wavelengths to generate different colors. The position of the spectral band can be adjusted by changing the thickness of the optical resonant cavity. One way of changing the optical resonant cavity is by changing the position of the reflector with respect to the absorber.

In some implementations, frontlight systems can be used to provide primary or supplemental illumination for a display device or other object to be illuminated. In particular, reflective display devices such as interferometric modulator-based devices or other electromechanical system (EMS) devices may utilize frontlight systems for illumination due to the opacity of the EMS devices. While a reflective display such as an IMOD-based display may in some implementations be visible in ambient light, some particular implementations of reflective displays may include supplemental lighting in the form of a frontlight system.

In some implementations, a frontlight system may include one or more light-guiding films or layers through which light can propagate, and one or more light-turning features to direct light out of the light-guiding films. Light can be injected into the light-guiding layer, and light-turning features can be used to reflect light within the light-guiding layer towards the reflective display and back through the light-guiding layer towards, for example, a viewer. Until light reaches a light-turning feature, the injected light may propagate within the light-guiding layer by means of total internal reflection so long as the material of the light-guiding layer has an index of refraction greater than that of the surrounding layers. Such a frontlight system allows an illuminating light source to be positioned at a location offset from the display or other object to be illuminated, such as at one of the edges of the frontlight film.

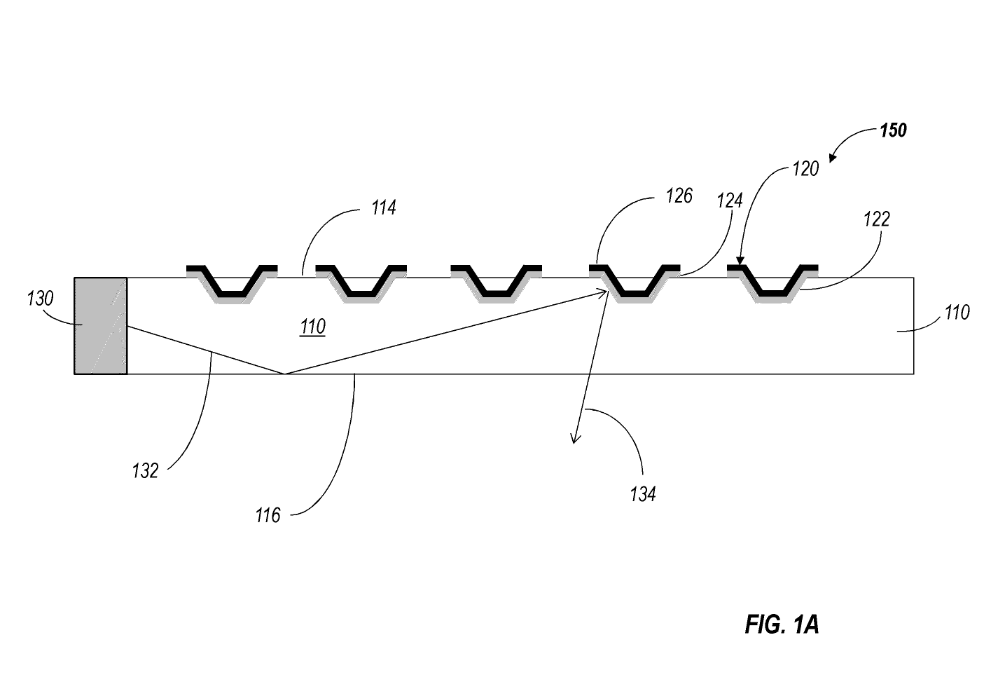

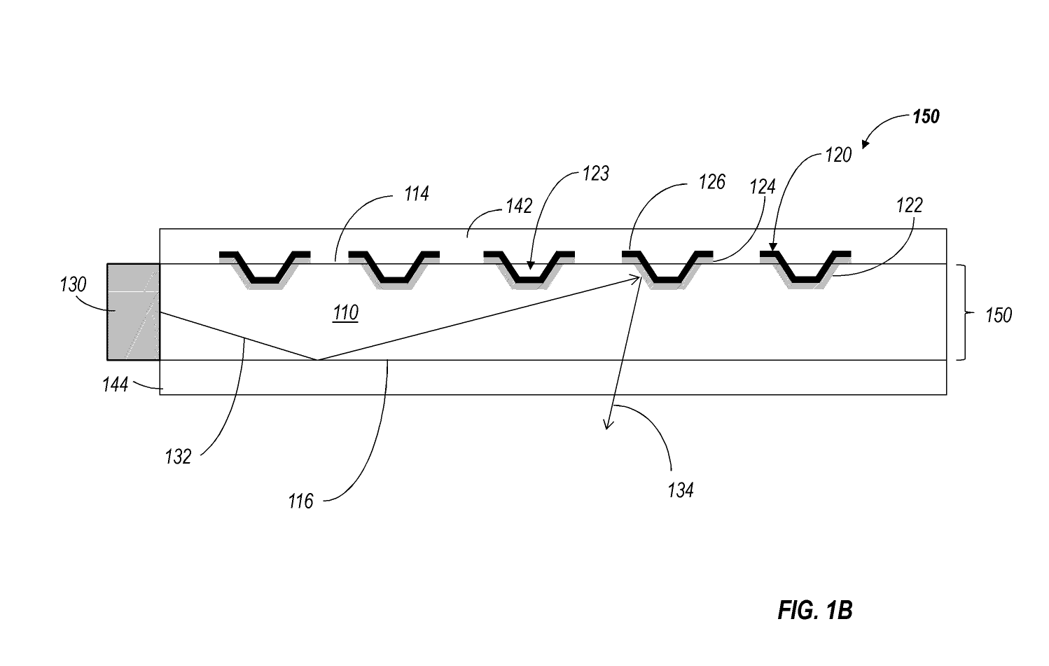

FIG. 1A shows a side cross-section of an example of a frontlight system configured to turn incident light out of plane of the device. The frontlight system 150 includes a light-guiding layer 110 which may have an index of refraction greater than air or any surrounding layers, as discussed above. The light-guiding layer 110 also may include a plurality of light-turning features 120 disposed along an upper surface 114 of the light-guiding layer 110.

These light-turning features 120 include a reflective layer 124 formed over a depression 118 in the light-guiding layer 110. The depression may be conical or frustoconical in shape, such that the portion of the reflective layer 124 in contact with an angled sidewall of the depression forms a reflective surface 122 oriented at an angle to the upper surface 114 and lower surface 116 of light-guiding layer 110. The light-turning features also may include a masking layer or masking layers 126 disposed on the opposite side of the reflective layer 124 as the light-turning film 110. The frontlight system 150 also includes one or more light sources such as LED 130 disposed adjacent an edge 112 of the light-guiding layer 110.

The LED 130 injects light 132 into the light-guiding film 110, which propagates by means of total internal reflection as shown until it strikes a reflective surface 122 of a light-turning feature 120. The light 134 reflected off the reflective surface 122 of the light-turning feature 120 is turned downwards towards lower surface 116 of the light-guiding layer 110. When the light 134 is reflected in a direction sufficiently close to the normal of the lower surface 116 of light-guiding layer 110, the light 134 passes through the lower surface 116 of light-guiding layer 110 without being reflected back into the light-guiding layer 110.

In the illustrated implementation, all light 132 propagating within the light-guiding layer 110 which is incident upon the reflective surface 122 will be turned downwards towards lower surface 116 of the frontlight film 110. In contrast, in frontlight systems which rely on total internal reflection at the reflective surfaces 122, the reflection or transmission of light reaching the reflective surfaces 122 may dependent on the angle at which the light 132 is incident upon a reflective surface of a light-turning feature. The use of a reflective layer 124 can therefore reduce light leakage from light-turning features 120, improving the efficiency of the frontlight system 150 as a larger amount of light can be directed downward and towards a reflective display or other object to be illuminated.

Although referred to for convenience as a frontlight film 110, the frontlight film 110 may in some implementations be a multilayer structure formed from layers having indices of refraction sufficiently close to one another that the frontlight film 110 generally functions as a single film, with minimal refraction and/or total internal reflection between the various sublayers of the frontlight film 110.

The frontlight system 150 thus redirects light 132 propagating within the light-guiding layer downward through the lower surface 116 of the light-guiding system 110. As illustrated in FIG. 1A, the frontlight system relies on the interface between air and the planar sections of the upper surface 114 and the lower surface 116 of frontlight film 110 to constrain light 134 propagating within the frontlight film 110 via total internal reflection (TIR). However, a frontlight system is often used as part of a multilayer structure, and contact between the frontlight film 110 and an adjacent high-index material may frustrate the total internal reflection and prevent the frontlight system 150 from operating as intended.

FIG. 1B shows a side cross-section of the example frontlight system of FIG. 1A surrounded by cladding layers. In some implementations, similar total internal reflection performance can be achieved by surrounding the light-guiding layer 110 with an upper cladding layer 142 and a lower cladding layer 144. The upper cladding layer 142 and lower cladding layer 144 can be formed from a material which has a lower index of refraction than the frontlight film 110. As can be seen in FIG. 1B, the upper cladding layer is formed over the upper surface 114 of the frontlight film 110 and is in contact with the planar portions of the upper surface 114 of the light-guiding layer 110 extending between the light-turning features 120, filling the depressions 123 in the upper surface of the light-turning features 120. These contact areas form an interface between the lower-index upper cladding layer 142 and the planar sections of the higher-index light-guiding layer 110 in order to facilitate total internal reflection of light propagating within the light-guiding layer before it reaches a light-turning feature 120.

In the illustrated implementation, the light-turning features 120 are formed by coating a depression in the underlying light-guiding layer 110 with a layer 124 of reflective material, to ensure that all light 134 incident upon the light-turning features 120 is reflected. However, coating the light-turning features 120 generally requires a precise fabrication process, increasing the cost and complexity of the fabrication process. Even if the reflective layer is masked on the other side, the use of an opaque reflective material within a frontlight film can alter the appearance of the underlying display or object. If the size of the light-turning feature can be reduced, the effect on the appearance of the underlying object can be minimized. Due to alignment tolerances, a lithographically patterned light-turning feature 120 can include sections of a reflective layer 124 and masking layer 126 which are larger than the underlying depression 118 to ensure that the underlying depression is fully covered by the layers of the light-turning feature 120.

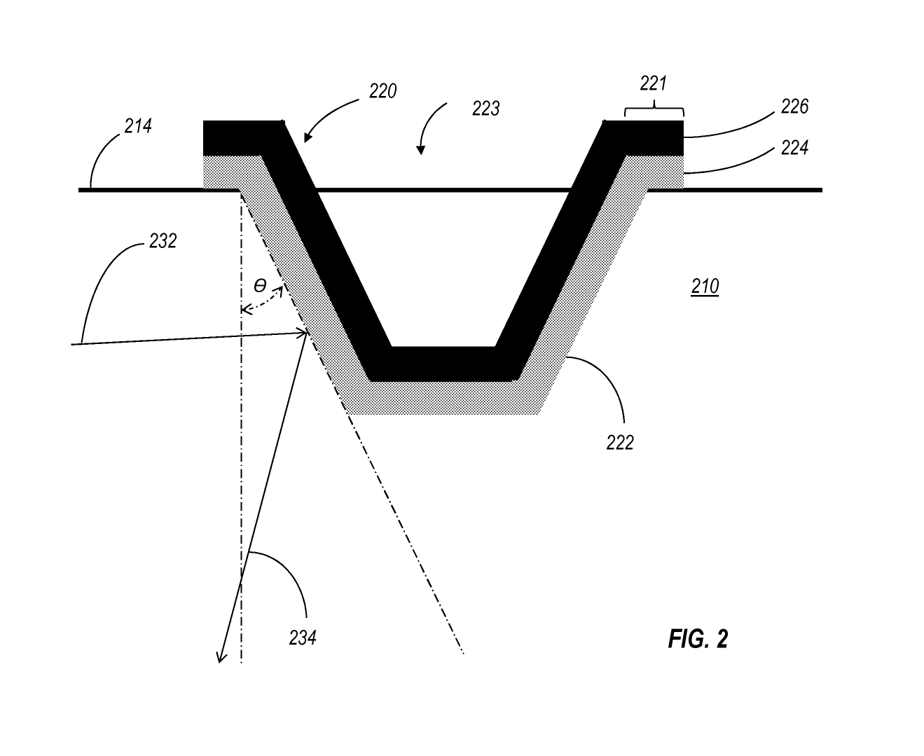

FIG. 2 is a detailed cross-sectional view of an example light-turning feature formed over a depression within a light-guiding layer. The angled surface 222 of the light-turning feature 220 makes an angle θ with the normal of the planar upper surface 214 of light-guiding layer 210. In some implementations, the angle θ may be between 35° and 50°, greater than 50°, or less than 35°. The top of the light-turning feature 220 may in some implementations be between roughly 5 um and 15 um in diameter, and the depth of the light turning feature 220 may be between roughly 1.5 um and 15 um. The base of the light-turning feature 220 may in some implementations be determined by the top diameter and depth of the light-turning feature 220 and the angle θ of the angled surface 222. In addition, the angle θ may be selected based in part upon the index of refraction of the light-guiding layer 210 and the indices of refraction of any other layers that the light turned out of the light-guiding layer 210 will pass through, as the indices of refraction of the cladding layers that surround the light-guiding layer 210 will affect the resultant direction of the reflected light.

When a light-turning feature relies on total internal reflection to redirect light incident upon the light-turning feature, rather than relying on the use of a reflective layer, only a portion of the light incident upon the light-turning feature will be reflected downwards, as the reflection or transmission of light via total internal reflection (TIR) will be dependent upon the angle of incidence. Strict control of the divergence of the light emitted by the light source and of the surface profile of the light-turning feature can increase the efficiency of a frontlight system which relies on TIR. In contrast, by using a light-turning feature such as light-turning feature 220 of FIG. 2, in which the angled surface 222 is reflective, such strict control over the divergence of the light emitted by the light source and the surface profile of the light-turning feature is less critical. Substantially all light incident upon the angled surface 222 of the light-turning feature 220 will be reflected.

In the illustrated implementation, the light-turning feature 220 is symmetric, with the angled surface 222 making the same angle θ with the normal of the planar upper surface 214 of light-guiding layer 210 on all sides. However, in some implementations, the light-turning feature 220 and the angled surface 222 may be asymmetrical, making a first angle with the normal of the planar upper surface 214 of light-guiding layer 210 on the side of the light-turning feature 220 facing a light source, and a different angle (either larger or smaller) on the opposite side of the light-turning feature 220. As light propagates through the light-guiding layer 210 of a frontlight film, a certain amount of light will be depleted by light-turning features 220. In some implementations, light that reaches the far edge of the light-guiding layer 210, opposite the edge of the light-guiding layer 210 at which light is injected, is reflected back into the light-guiding layer 210 where it can be redirected out by the light-turning features 220 as it propagates back through the light-guiding layer 210.

As discussed above, the light-turning feature 220 is larger than the underlying depression in the light-guiding layer 210, and includes a lip 221 extending over the planar upper surface 214 of the light-guiding layer 210. In some implementations, the size of the lip 221 is dependent upon the alignment tolerance of a lithography process used to pattern and etch the materials which form the light-turning feature 220, to ensure that the entire angled surface of the underlying depression 218 is covered by the reflective layer 224 to form an angled reflective surface 222. A reduction in the diameter of light-turning features 220 will have a significant effect on the total area blocked by light-turning features 220 while still maintaining the same efficacy of the light-turning features in turning light downward while preventing leakage. In particular, a significant reduction in the size of lip 221 or the elimination of lip 221 can reduce the visual impact of the opaque light-turning features 220. In an implementation in which the reflective layer 224 and masking layer 226 are conformal over the underlying layers, a depression 223 in the upper surface of the light-turning feature 220 is shaped similarly to but slightly narrower than the underlying depression in the light-guiding layer 210, due to the thicknesses of the reflective layer 224 and masking layer 226.

In some implementations, the underlying depression in the light-guiding layer 210 can be formed at the same time that the reflective layer 224 and masking layer 226 are patterned to form the light-turning features. For example, a single embossing tool can be used to form the depressions in a sufficiently deformable light-guiding layer 210 while mechanically separating the portions of the reflective layer 224 and masking layer 226 which are removed to form the light-turning features 220. By performing both of these processes in a single step using a single tool, the light-turning features 220 can be precisely aligned with the underlying depressions in a sufficiently deformable light-guiding layer 210. Because precise alignment can be provided, the lip 221 of the light-turning features 220 can be significantly reduced in size or eliminated altogether.

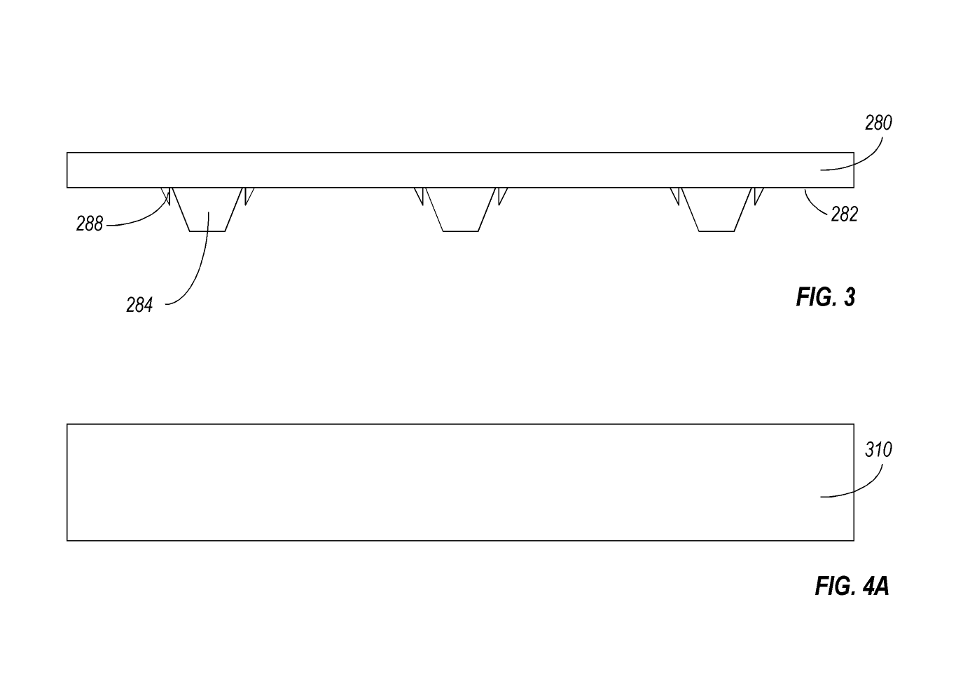

FIG. 3 shows a side cross-section of a stamping mold which can be used to mechanically define a light-turning feature. The mold 280 includes a lower surface 282 including positive relief features 284 which are the inverse of the depressions 223 to be formed in the upper surface of light-turning features 220, and which are shaped similarly to the underlying depressions to be formed in the light-guiding layer 210 (see FIG. 2). The sections of the lower surface 282 of mold 280 extending between the positive relief features 284 are generally planar and will not substantially deform an underlying layer during an embossing section. In order to form light-turning features 220 as described above, having sidewalls which make an angle with the normal of the planar upper surface of the light-guiding layer 220 of between 35° and 50°, the positive relief features 284 have sidewalls oriented at the same angle to the normal of the planar sections of the lower surface 282 of mold 280. Thus, the sidewalls of the positive relief features 284 make a complementary angle of between 40° and 55°, with the plane of the lower surface 282 of mold 280. Extending around the periphery of the positive relief features 284 is a raised feature 288 configured to mechanically separate a section of a film or multilayer film stack from the remainder of the film or multilayer film stack to form a light-turning feature 220 adjacent a depression 218 embossed into a light-guiding layer. The raised feature 288 thus provides one means for mechanically separating a portion of an embossed layer from a surrounding portion of an embossed layer. The spacing between the positive relief feature 284 and the raised feature 218 will, in conjunction with the thickness of the film or multilayer film stack to be mechanically separated, determine the presence of and/or size of the lip 221 extending around the edge of the light-turning features formed using the mold 280.

In some implementations, the lower surface 282 of the mold 280 may include differing surface properties in different sections of the lower surface 282 of the mold 280 to facilitate selective removal of portions of a film or multilayer film stack to form light-turning features 220. These differing surface properties may be used in conjunction with or in place of the raised cutting feature 288 to facilitate selective removable of portions of the film or multilayer film stack to form light turning features 220. In particular, the sections of the lower surface 282 of mold 280 adjacent the positive relief features 284 may be configured to adhere less strongly to the film or multilayer film stack which will form light-turning features 220 than sections of the lower surface 282 of mold 280 located away from the positive relief features 284. In implementations in which the lower surface 282 of mold 280 includes both raised cutting features 288 and sections with differing adhesive properties, the portions of the lower surface 282 of mold 280 within raised cutting features 288 may be less adhesive than the portions of the lower surface 282 of mold 280 outside of raised cutting features 288. In some other implementations, a difference in adhesive properties between the portions of the lower surface 282 of mold 280 located adjacent the positive relief features 284 and the portions of the lower surface 282 of mold 280 located away from the positive relief features 284 can be used to selectively remove sections of a film or multilayer film structure located away from the positive relief features 284 by pulling those sections away from the sections of the film or multilayer film structure located adjacent the positive relief features 284. A difference in the adhesive properties of various sections of the mold 280 can provide another means for mechanically separating a portion of an embossed layer from a surrounding portion of an embossed layer.

In some implementations, the mold 280 can be formed by first forming a negative version of the mold 280 in a material which can be precisely micromachined or otherwise shaped, followed by electroplating or casting the mold 280 on the upper surface of the negative version. The mold 280 can be subsequently reused to mass-produce frontlight films having light-turning features 220 formed thereon via an embossing process.

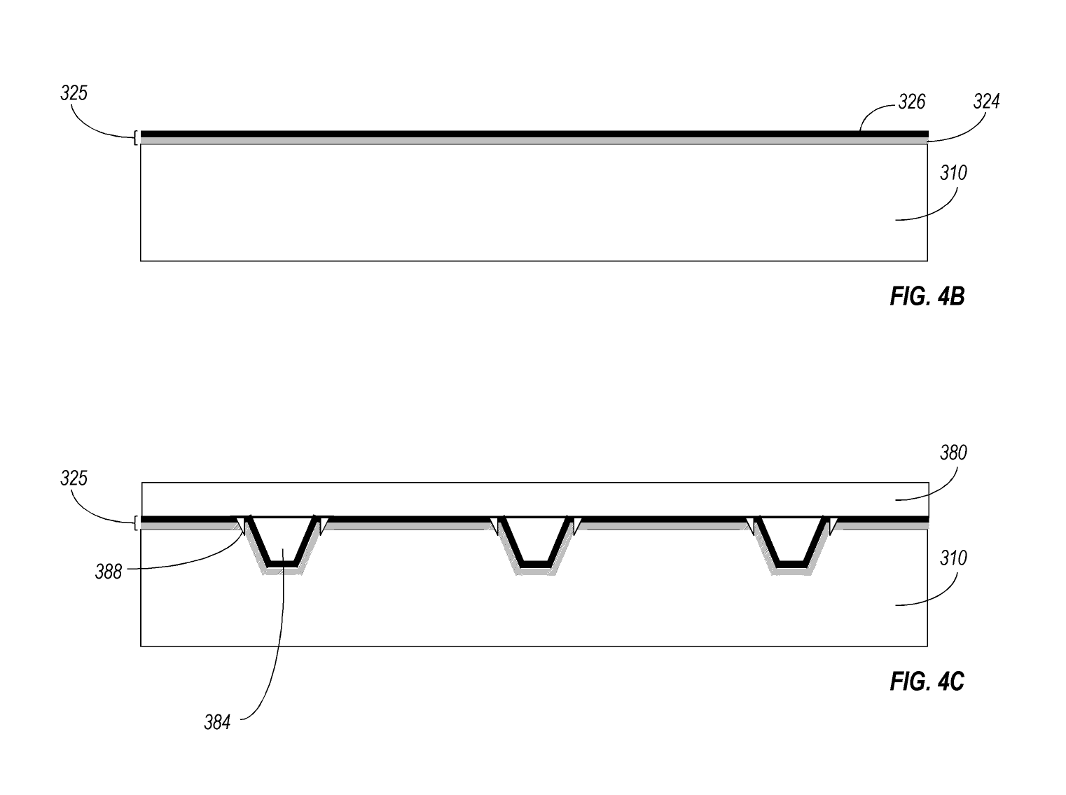

FIGS. 4A-4D illustrate various stages in an example fabrication process for forming a multilayer structure including embossed light-turning features. In FIG. 4A, a high-index layer 310 is provided, which will serve as a light-guiding layer in the finished multilayer structure. In some implementations, the high-index layer 310 may be a layer of a thermoset plastic, but other materials also may be used. In some implementations, the high-index layer may include a polycarbonate material, a polyethylene terephthalate (PET) material, or a material such as ZEONOR® sold by Zeon Corporation. Because the high-index layer 310 will be embossed to form depressions therein, the high-index layer 310 may be heated to soften the high-index layer 310 and facilitate the embossing process. In some implementations, the high-index layer 310 may be heated to a temperature close to the glass transition temperature of the material of the high-index layer 310.

In FIG. 4B, a multilayer film structure 325 is brought into contact with the upper surface of the high-index light-guiding layer 310. In the illustrated implementation, the multilayer film structure 325 may include a polymerized aluminum layer including a reflective sublayer 324 formed from aluminum or an aluminum alloy such as an aluminum-copper alloy. The reflective sublayer 324 is brought into contact with the high-index light-guiding layer 310 and a masking layer 326 such as a dark or opaque polymer sublayer or a dark chrome metal may be located on the opposite side of the reflective sublayer 324 as the light-guiding layer 310. The material of the high-index layer 310 may be selected to provide good adhesion between the high-index layer 310 and the reflective sublayer 324, or may be treated to increase adhesion between the high-index layer 310 and the reflective sublayer 324.

In FIG. 4C, a mold 380 is brought into contact with the upper surface of the multilayer film structure 325 and pressure is applied to deform the underlying high-index layer 310, with the multilayer film structure 325 being forced into a conformal shape between the mold 380 and the embossed underlying high-index layer 310. In the illustrated implementation, it can be seen that the mold 380 includes a raised cutting feature 388 which mechanically separates the portions of the multilayer film structure 325 located away from the positive relief feature 384 from the sections of the multilayer film structure 325 located adjacent the positive relief feature 384. Because this mechanical separation occurs at the same time that the positive relief feature 384 of the mold 380 embosses a depression in the underlying high-index layer 310, the separated section of the multilayer film structure 325 will be aligned with the underlying depression in the high-index layer 310.

In FIG. 4D, the mold 380 has been removed, and the portions of the multilayer film structure 325 located away from the underlying depression in the high-index layer 310 have been removed, forming light-turning features 320. In some implementations, differential adhesion between different portions of the mold 380 (see FIG. 4C) will result in the portions of the multilayer film structure 325 located away from the underlying depression in the high-index layer 310 being removed as the mold 380 is pulled away. In some other implementations, the portions of the multilayer film structure 325 located away from the underlying depression in the high-index layer 310 are removed in a separate step. As can be seen in FIG. 4D, the remaining portion of the multilayer film structure 325 (see FIG. 4C) which forms the light-turning structure 320 does not include a significant portion extending over the planar portion of the upper surface 314 of high-index layer 310, due to the precise alignment provided by the embossing process. In some implementations, as illustrated in FIG. 4D, the light-turning feature 320 does not extend laterally beyond the edges of the underlying depression in the high-index layer 310.

In some implementations, some or all of the process steps described above may be formed as part of a roll-to-roll fabrication process. For example, the high-index layer 310 may be heated and then brought into contact with the multilayer film structure 325 via a first roll or set of rolls. The mold 380 also may be disposed on a surface of a roll and used to emboss the combined high-index layer 310 and multilayer film structure 325 while simultaneously mechanically separating portions of the multilayer film structure 325. The roll-to-roll process also can be used to form layers not depicted in FIG. 4D. For example, a cladding layer having an index of refraction lower than that of the high-index layer 310 can be disposed over the top of the high-index layer 310 and the light-turning features 320. Similarly, a low-index cladding layer may be disposed on the opposite side of the high-index layer 310 as the light-turning features 320. In this way, a substantially complete frontlight film having light-turning features and outer cladding layers can be formed by a roll-to-roll process and applied to or over any object to be illuminated. A complete frontlight system can then be provided by simply disposing one or more light sources adjacent the high-index layer 310 to inject light into the high-index layer 310.

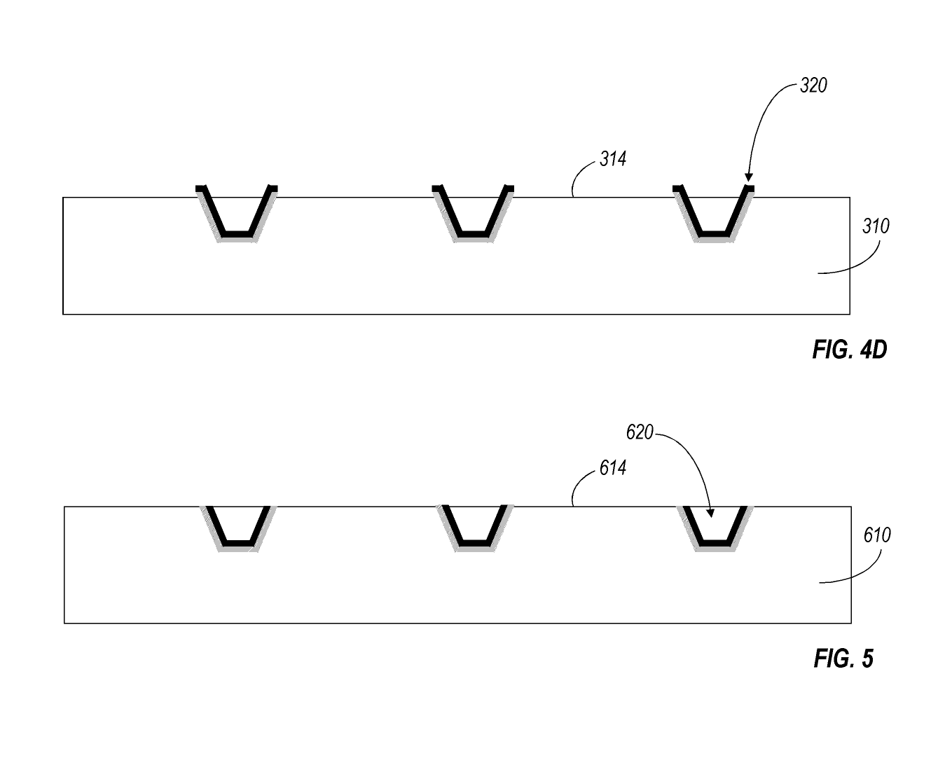

FIG. 5 is a side-cross sectional view of another example of a multilayer structure including light-turning features. A wide variety of processes can be used to remove portions of a reflective layer or multilayer structure located away from depressions in an underlying substrate. In the structure of FIG. 5, a multilayer film structure has been formed over a high-index layer 610 having depressions formed therein, and the portions of the multilayer film structure located away from the depressions in the high-index layer 610 have been removed to leave light-turning features 620 formed from the residual portions of the multilayer film within the depressions. In particular, it can be seen that the light-turning features 620 do not extend vertically above the substantially planar portions 614 of the upper surface of the high-index film.

A structure in which the light-turning features 620 do not extend beyond the upper surface of the high-index film can be formed by a variety of manufacturing processes. In some implementations, a blade or similar structure can be moved along the upper surface of the high-index film 610 in order to scrape off the portions of the multilayer film structure which are located above the plane of the upper surface of the multilayer film structure.

In some other implementations, an electrochemical etching process can be used to selectively remove portions of a multilayer structure in order to form light-turning features 620 within depressions in the high-index layer 610. In some implementations, the high-index layer 610 with a multilayer structure formed thereon can be immersed in an electrolyte and a tool electrode brought into close proximity to the multilayer structure. The local accumulation of charge within a conductive structure within the multilayer structure, such as an aluminum reflective layer, may induce an electrochemical reaction which etches the multilayer structure. Because the etching rate in such an electrochemical etching process is highly dependent upon the distance between the conductive material to be etched and the tool, a maskless electromechanical process can be used to remove the portions of the multilayer extending over the planar sections of the high-index layer 610.

In some implementations, a combination of processes may be used. For example, portions of the multilayer structure within the depressions may be mechanically and electrically isolated form the surrounding sections during an embossing process, leaving one or more contiguous sections of the multilayer structure located over substantially planar portions of the high-index layer 610. These contiguous sections of the multilayer structure may be removed via an electrochemical etching process, leaving behind sections of the multilayer film within the depressions in the high-index layer 610 to form light-turning features 620 within the depressions.

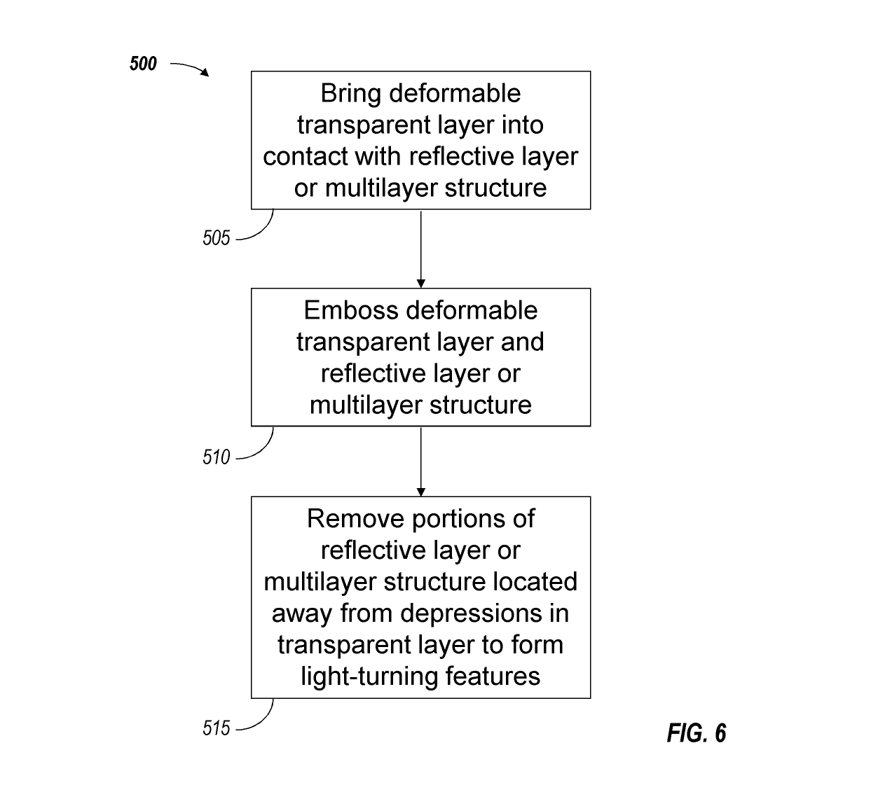

FIG. 6 is a flow diagram illustrating an example fabrication process for a multilayer structure including light-turning features mechanically defined during an embossing process. In block 505 of the fabrication process 500, a deformable transparent layer is provided, and a reflective layer is brought into contact with the deformable transparent layer. In some implementations, the reflective layer may be part of a multilayer structure including a reflective sublayer and a masking sublayer, where the reflective sublayer is brought into contact with the deformable transparent layer. In some implementations, the deformable transparent layer may be a high-index layer. In some implementations, the deformable transparent layer may be a plastic thermoset material, and may be heated to a temperature near the glass transition temperature of the plastic layer in order to facilitate the subsequent embossing process. The heating may occur before or after the reflective layer is brought into contact with the transparent layer.

In block 510 of the fabrication process 500, a mold including positive relief features is brought into contact with the reflective layer or multilayer film structure to emboss the underlying high-index layer. In some implementations, the mold also may include raised cutting features to mechanically separate sections of the multilayer film structure adjacent the underlying depressions in the high-index layer from surrounding sections of the multilayer film structure.

In block 515 of the fabrication process 500, the mold is removed, and portions of the multilayer film structure located away from the underlying depressions in the high-index layer are also removed. Light-turning features overlying the depressions in the high-index layer are thereby formed. In some implementations, differential adhesion may be used to remove the portions of the multilayer film structure located away from the underlying depressions in the high-index layer at the same time that the mold is removed. In some other implementations, the surrounding portions of the multilayer film structure may be removed in a separate step, such as through the use of a blade or an electrochemical etching process to remove undesired portions of the multilayer film structure. As discussed above, some or all of these processes may be performed as part of a roll-to-roll fabrication process.

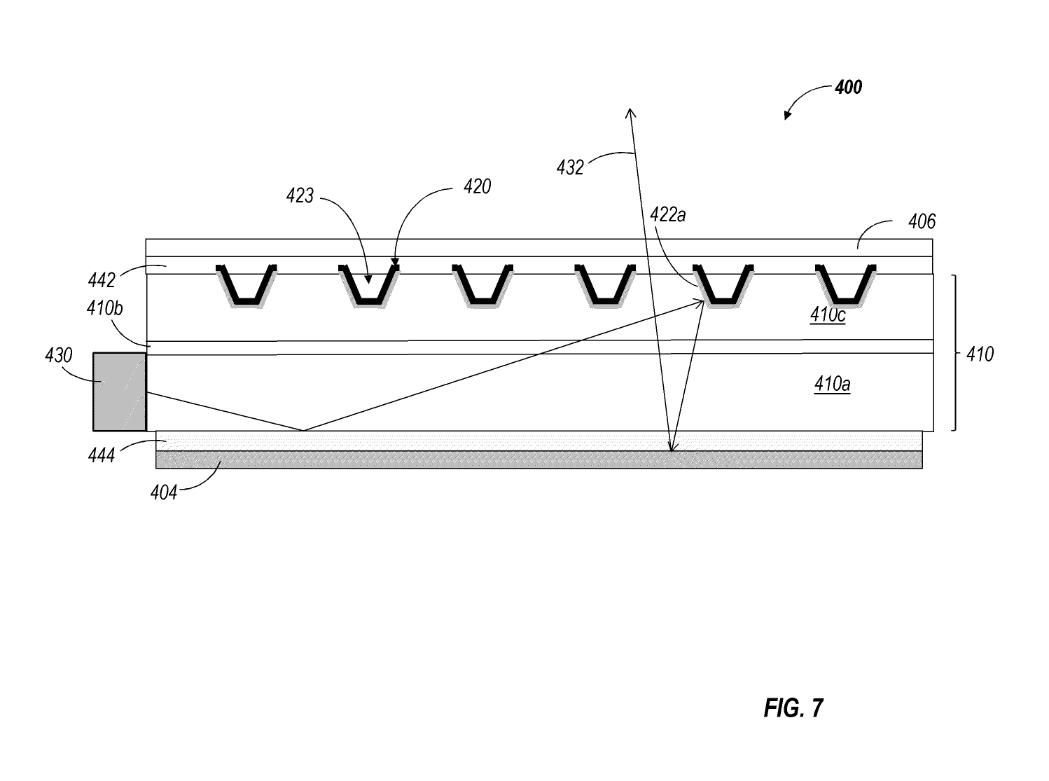

FIG. 7 is a cross-sectional view of an example display device including a frontlight system which includes light-turning features mechanically defined by an embossing process. In the implementation of FIG. 7, the light-guiding layer 410 is a multilayer structure, including a display substrate 410a, a light-turning sublayer 410c in which the light-turning features 420 are formed, and an optically clear adhesion layer 410b securing the display substrate 410a to the light-turning sublayer 410c. Although depicted as being substantially similar in thickness in FIG. 7, the display substrate 410a and the light-turning sublayer 410c can in some implementations be substantially different in thickness. In some implementations, the display substrate 410a can be substantially thicker than the light-turning sublayer 410c, and also may be formed from a more rigid material than the light-turning sublayer 410c, such as glass or a stiff plastic material, while the light-turning sublayer 410c may be formed from a more malleable plastic which allows the embossing of the light-turning features.

In implementations in which the display substrate 410a and the light-turning sublayer 410c are formed from different materials, they may be formed from materials which have similar indices of refraction. The light-turning sublayer 410c is sufficiently thick that the light-turning features 420 can be formed therein, and may in some implementations be roughly 100 um thick, although other thickness also may be used. The adhesive layer 410b may be formed of an optically clear adhesive having an index of refraction between the indices of refraction of the display substrate 410a and the light-turning sublayer 410c. Other materials, thicknesses, and arrangements of layers also may be used, however. To eliminate total internal reflection from the interface between the display substrate 410 and the adhesion layer 410b, and the interface between the adhesion layer 410b and the light-turning layer 410c, refractive index of the adhesion layer 410b should be slightly higher than the refractive index of the display substrate 410a, and the refractive index of the light-turning layer 410c should be slightly higher than the refractive index of the adhesion layer 410b.

In implementations such as the display device 400 depicted in FIG. 7, in which the display substrate 410a forms a part of the light-guiding layer 410, a low-index lower cladding layer 444 may be disposed between the display substrate 410a and a reflective display 404 supported by the display substrate 410a. In some implementations, the lower cladding layer 444 may be formed prior to the formation of an array of reflective display elements such as interferometric modulators (discussed in greater detail below) which form part of the reflective display 404. An upper low-index cladding layer 442 is formed over the light-turning sublayer 410c. In the illustrated implementation, as discussed above, the upper cladding layer is in contact with the planar portions of the upper surface 414 of the light-guiding layer 410 extending between the light-turning features 420, and also may fill the depressions 423 in the upper surface of light-turning features 420. In some implementations, the light-turning sublayer 410c and upper cladding layer 442 may be a multilayer structure formed as part of a roll-to-roll process or other manufacturing process, and adhered to the display substrate 410a. A protective cover 406 may be disposed over the upper cladding layer 406, and may in some implementations be a cover glass.

Light 432 injected via light source 430 may propagate freely within the sublayers of the light-guiding layer 410 via total internal reflection until it reaches an angled sidewall 422 of a light-turning feature 420. The light-turning feature 420 reflects the light downward and out of the light-guiding layer 410 at an angle sufficiently close to the normal that the light 432 is not totally internally reflected at the boundary between the high-index light-guiding layer 410 and the low-index cladding layer 444. The light 432 illuminates the reflective display 404 and is reflected back up and through the light-guiding layer 410 to, for example, a viewer.

The above implementations of frontlight systems and components may be used to illuminate a wide variety of objects, including but not limited to reflective displays. One non-limiting example of a reflective display type with which the frontlight systems and components described herein may be used is an interferometric modulator (IMOD) based display.

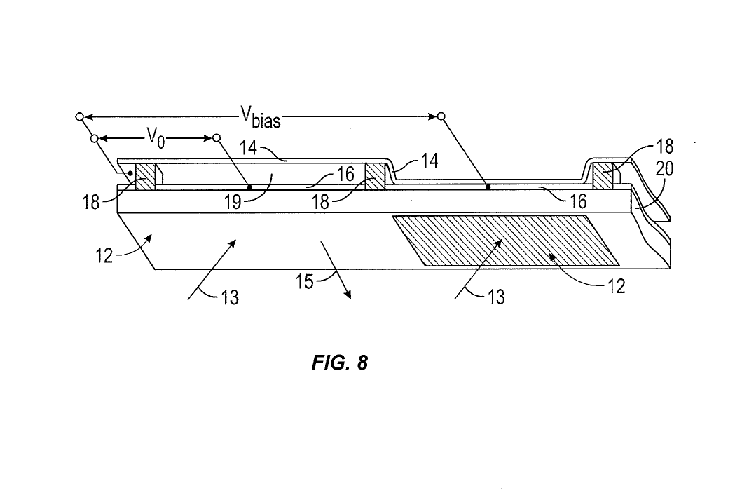

FIG. 8 is an isometric view illustration depicting two adjacent interferometric modulator (IMOD) display elements in a series or array of display elements of an IMOD display device. The IMOD display device includes one or more interferometric EMS, such as MEMS, display elements. In these devices, the interferometric MEMS display elements can be configured in either a bright or dark state. In the bright (“relaxed,” “open” or “on,” etc.) state, the display element reflects a large portion of incident visible light. Conversely, in the dark (“actuated,” “closed” or “off,” etc.) state, the display element reflects little incident visible light. MEMS display elements can be configured to reflect predominantly at particular wavelengths of light allowing for a color display in addition to black and white. In some implementations, by using multiple display elements, different intensities of color primaries and shades of gray can be achieved.

The IMOD display device can include an array of IMOD display elements which may be arranged in rows and columns. Each display element in the array can include at least a pair of reflective and semi-reflective layers, such as a movable reflective layer (i.e., a movable layer, also referred to as a mechanical layer) and a fixed partially reflective layer (i.e., a stationary layer), positioned at a variable and controllable distance from each other to form an air gap (also referred to as an optical gap, cavity or optical resonant cavity). The movable reflective layer may be moved between at least two positions. For example, in a first position, i.e., a relaxed position, the movable reflective layer can be positioned at a distance from the fixed partially reflective layer. In a second position, i.e., an actuated position, the movable reflective layer can be positioned more closely to the partially reflective layer. Incident light that reflects from the two layers can interfere constructively and/or destructively depending on the position of the movable reflective layer and the wavelength(s) of the incident light, producing either an overall reflective or non-reflective state for each display element. In some implementations, the display element may be in a reflective state when unactuated, reflecting light within the visible spectrum, and may be in a dark state when actuated, absorbing and/or destructively interfering light within the visible range. In some other implementations, however, an IMOD display element may be in a dark state when unactuated, and in a reflective state when actuated. In some implementations, the introduction of an applied voltage can drive the display elements to change states. In some other implementations, an applied charge can drive the display elements to change states.

The depicted portion of the array in FIG. 8 includes two adjacent interferometric MEMS display elements in the form of IMOD display elements 12. In the display element 12 on the right (as illustrated), the movable reflective layer 14 is illustrated in an actuated position near, adjacent or touching the optical stack 16. The voltage V_{bias} applied across the display element 12 on the right is sufficient to move and also maintain the movable reflective layer 14 in the actuated position. In the display element 12 on the left (as illustrated), a movable reflective layer 14 is illustrated in a relaxed position at a distance (which may be predetermined based on design parameters) from an optical stack 16, which includes a partially reflective layer. The voltage V₀ applied across the display element 12 on the left is insufficient to cause actuation of the movable reflective layer 14 to an actuated position such as that of the display element 12 on the right.

In FIG. 8, the reflective properties of IMOD display elements 12 are generally illustrated with arrows indicating light 13 incident upon the IMOD display elements 12, and light 15 reflecting from the display element 12 on the left. Most of the light 13 incident upon the display elements 12 may be transmitted through the transparent substrate 20, toward the optical stack 16. A portion of the light incident upon the optical stack 16 may be transmitted through the partially reflective layer of the optical stack 16, and a portion will be reflected back through the transparent substrate 20. The portion of light 13 that is transmitted through the optical stack 16 may be reflected from the movable reflective layer 14, back toward (and through) the transparent substrate 20. Interference (constructive and/or destructive) between the light reflected from the partially reflective layer of the optical stack 16 and the light reflected from the movable reflective layer 14 will determine in part the intensity of wavelength(s) of light 15 reflected from the display element 12 on the viewing or substrate side of the device. In some implementations, the transparent substrate 20 can be a glass substrate (sometimes referred to as a glass plate or panel). The glass substrate may be or include, for example, a borosilicate glass, a soda lime glass, quartz, Pyrex, or other suitable glass material. In some implementations, the glass substrate may have a thickness of 0.3, 0.5 or 0.7 millimeters, although in some implementations the glass substrate can be thicker (such as tens of millimeters) or thinner (such as less than 0.3 millimeters). In some implementations, a non-glass substrate can be used, such as a polycarbonate, acrylic, polyethylene terephthalate (PET) or polyether ether ketone (PEEK) substrate. In such an implementation, the non-glass substrate will likely have a thickness of less than 0.7 millimeters, although the substrate may be thicker depending on the design considerations. In some implementations, a non-transparent substrate, such as a metal foil or stainless steel-based substrate can be used. For example, a reverse-IMOD-based display, which includes a fixed reflective layer and a movable layer which is partially transmissive and partially reflective, may be configured to be viewed from the opposite side of a substrate as the display elements 12 of FIG. 8 and may be supported by a non-transparent substrate.

The optical stack 16 can include a single layer or several layers. The layer(s) can include one or more of an electrode layer, a partially reflective and partially transmissive layer, and a transparent dielectric layer. In some implementations, the optical stack 16 is electrically conductive, partially transparent and partially reflective, and may be fabricated, for example, by depositing one or more of the above layers onto a transparent substrate 20. The electrode layer can be formed from a variety of materials, such as various metals, for example indium tin oxide (ITO). The partially reflective layer can be formed from a variety of materials that are partially reflective, such as various metals (such as chromium and/or molybdenum), semiconductors, and dielectrics. The partially reflective layer can be formed of one or more layers of materials, and each of the layers can be formed of a single material or a combination of materials. In some implementations, certain portions of the optical stack 16 can include a single semi-transparent thickness of metal or semiconductor which serves as both a partial optical absorber and electrical conductor, while different, electrically more conductive layers or portions (such as of the optical stack 16 or of other structures of the display element) can serve to bus signals between IMOD display elements. The optical stack 16 also can include one or more insulating or dielectric layers covering one or more conductive layers or an electrically conductive/partially absorptive layer.

In some implementations, at least some of the layer(s) of the optical stack 16 can be patterned into parallel strips, and may form row electrodes in a display device as described further below. As will be understood by one having ordinary skill in the art, the term “patterned” is used herein to refer to masking as well as etching processes. In some implementations, a highly conductive and reflective material, such as aluminum (Al), may be used for the movable reflective layer 14, and these strips may form column electrodes in a display device. The movable reflective layer 14 may be formed as a series of parallel strips of a deposited metal layer or layers (orthogonal to the row electrodes of the optical stack 16) to form columns deposited on top of supports, such as the illustrated posts 18, and an intervening sacrificial material located between the posts 18. When the sacrificial material is etched away, a defined gap 19, or optical cavity, can be formed between the movable reflective layer 14 and the optical stack 16. In some implementations, the spacing between posts 18 may be approximately 1-1000 μm, while the gap 19 may be approximately less than 10,000 Angstroms (Å).

In some implementations, each IMOD display element, whether in the actuated or relaxed state, can be considered as a capacitor formed by the fixed and moving reflective layers. When no voltage is applied, the movable reflective layer 14 remains in a mechanically relaxed state, as illustrated by the display element 12 on the left in FIG. 8, with the gap 19 between the movable reflective layer 14 and optical stack 16. However, when a potential difference, i.e., a voltage, is applied to at least one of a selected row and column, the capacitor formed at the intersection of the row and column electrodes at the corresponding display element becomes charged, and electrostatic forces pull the electrodes together. If the applied voltage exceeds a threshold, the movable reflective layer 14 can deform and move near or against the optical stack 16. A dielectric layer (not shown) within the optical stack 16 may prevent shorting and control the separation distance between the layers 14 and 16, as illustrated by the actuated display element 12 on the right in FIG. 8. The behavior can be the same regardless of the polarity of the applied potential difference. Though a series of display elements in an array may be referred to in some instances as “rows” or “columns,” a person having ordinary skill in the art will readily understand that referring to one direction as a “row” and another as a “column” is arbitrary. Restated, in some orientations, the rows can be considered columns, and the columns considered to be rows. In some implementations, the rows may be referred to as “common” lines and the columns may be referred to as “segment” lines, or vice versa. Furthermore, the display elements may be evenly arranged in orthogonal rows and columns (an “array”), or arranged in non-linear configurations, for example, having certain positional offsets with respect to one another (a “mosaic”). The terms “array” and “mosaic” may refer to either configuration. Thus, although the display is referred to as including an “array” or “mosaic,” the elements themselves need not be arranged orthogonally to one another, or disposed in an even distribution, in any instance, but may include arrangements having asymmetric shapes and unevenly distributed elements.

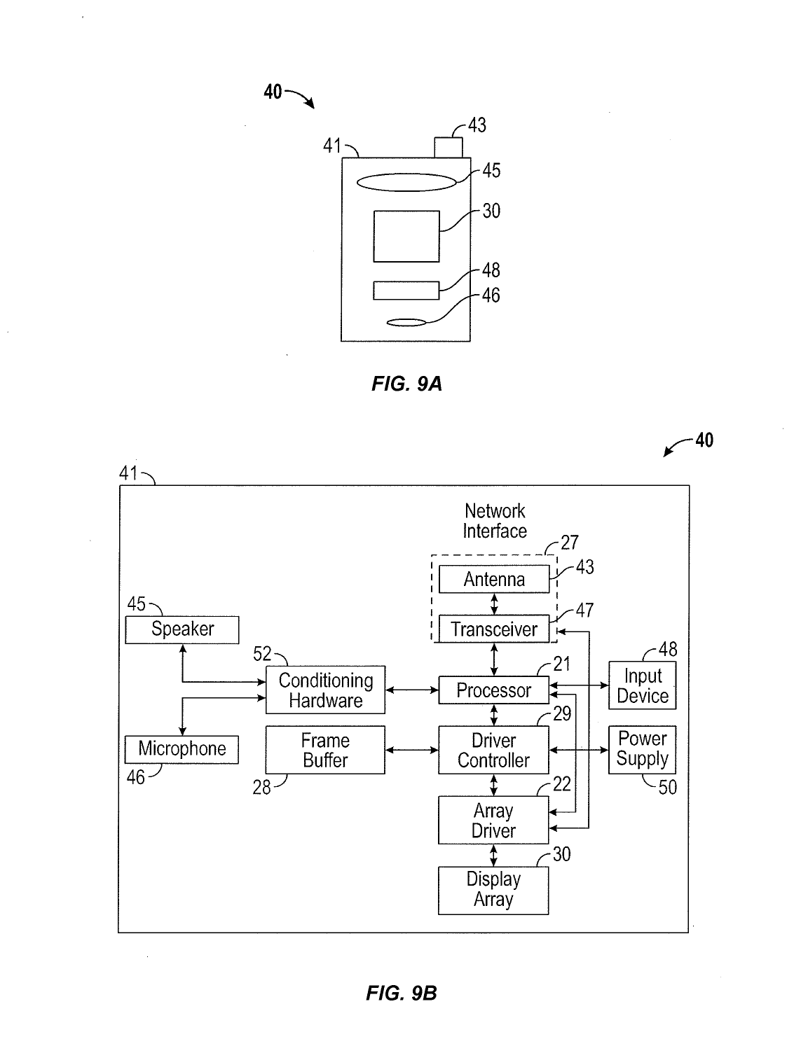

FIGS. 9A and 9B are system block diagrams illustrating a display device 40 that includes a plurality of IMOD display elements. The display device 40 can be, for example, a smart phone, a cellular or mobile telephone. However, the same components of the display device 40 or slight variations thereof are also illustrative of various types of display devices such as televisions, computers, tablets, e-readers, hand-held devices and portable media devices.

The display device 40 includes a housing 41, a display 30, an antenna 43, a speaker 45, an input device 48 and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can be configured to include a flat-panel display, such as plasma, EL, OLED, STN LCD, or TFT LCD, or a non-flat-panel display, such as a CRT or other tube device. In addition, the display 30 can include an IMOD-based display, as described herein.

The components of the display device 40 are schematically illustrated in FIG. 9B. The display device 40 includes a housing 41 and can include additional components at least partially enclosed therein. For example, the display device 40 includes a network interface 27 that includes an antenna 43 which can be coupled to a transceiver 47. The network interface 27 may be a source for image data that could be displayed on the display device 40. Accordingly, the network interface 27 is one example of an image source module, but the processor 21 and the input device 48 also may serve as an image source module. The transceiver 47 is connected to a processor 21, which is connected to conditioning hardware 52. The conditioning hardware 52 may be configured to condition a signal (such as filter or otherwise manipulate a signal). The conditioning hardware 52 can be connected to a speaker 45 and a microphone 46. The processor 21 also can be connected to an input device 48 and a driver controller 29. The driver controller 29 can be coupled to a frame buffer 28, and to an array driver 22, which in turn can be coupled to a display array 30. One or more elements in the display device 40, including elements not specifically depicted in FIG. 9A, can be configured to function as a memory device and be configured to communicate with the processor 21. In some implementations, a power supply 50 can provide power to substantially all components in the particular display device 40 design.

The network interface 27 includes the antenna 43 and the transceiver 47 so that the display device 40 can communicate with one or more devices over a network. The network interface 27 also may have some processing capabilities to relieve, for example, data processing requirements of the processor 21. The antenna 43 can transmit and receive signals. In some implementations, the antenna 43 transmits and receives RF signals according to the IEEE 16.11 standard, including IEEE 16.11(a), (b), or (g), or the IEEE 802.11 standard, including IEEE 802.11a, b, g, n, and further implementations thereof. In some other implementations, the antenna 43 transmits and receives RF signals according to the Bluetooth® standard. In the case of a cellular telephone, the antenna 43 can be designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), NEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G, 4G or 5G technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, in some implementations, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that can be readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation and gray-scale level.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29, such as an LCD controller, is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of display elements.

In some implementations, the driver controller 29, the array driver 22, and the display array 30 are appropriate for any of the types of displays described herein. For example, the driver controller 29 can be a conventional display controller or a bi-stable display controller (such as an IMOD display element controller). Additionally, the array driver 22 can be a conventional driver or a bi-stable display driver (such as an IMOD display element driver). Moreover, the display array 30 can be a conventional display array or a bi-stable display array (such as a display including an array of IMOD display elements). In some implementations, the driver controller 29 can be integrated with the array driver 22. Such an implementation can be useful in highly integrated systems, for example, mobile phones, portable-electronic devices, watches or small-area displays.

In some implementations, the input device 48 can be configured to allow, for example, a user to control the operation of the display device 40. The input device 48 can include a keypad, such as a QWERTY keyboard or a telephone keypad, a button, a switch, a rocker, a touch-sensitive screen, a touch-sensitive screen integrated with the display array 30, or a pressure- or heat-sensitive membrane. The microphone 46 can be configured as an input device for the display device 40. In some implementations, voice commands through the microphone 46 can be used for controlling operations of the display device 40.

The power supply 50 can include a variety of energy storage devices. For example, the power supply 50 can be a rechargeable battery, such as a nickel-cadmium battery or a lithium-ion battery. In implementations using a rechargeable battery, the rechargeable battery may be chargeable using power coming from, for example, a wall socket or a photovoltaic device or array. Alternatively, the rechargeable battery can be wirelessly chargeable. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm steps described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and steps described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular steps and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein. Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of, for example, an IMOD display element as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, a person having ordinary skill in the art will readily recognize that such operations need not be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. A device comprising:
a light-guiding layer capable of constraining light propagating therein, the light-guiding layer including a plurality of depressions embossed in a first surface of the light-guiding layer; and
a plurality of light-turning features disposed within the depressions in the first-surface of the light-guiding layer and including a reflective layer extending adjacent the depressions without extending laterally beyond the edges of the depressions in the light-guiding layer and over a substantially planar portion of the first surface of the light-guiding layer.

2. The device of claim 1, wherein the light-turning features include an angled sidewall oriented at an angle to the first surface of the light-guiding layer and capable of turning light propagating within the light-guiding layer out of the light-guiding layer.

3. The device of claim 2, wherein the angles between the sidewalls of the light-turning features and lines normal to the substantially planar portions of the first surface of the light guiding layer are between 35° and 50°.

4. The device of claim 1, wherein the plurality of light-turning features have a diameter of between 5 and 15 um at their widest point.

5. The device of claim 1, wherein the depressions in the first-surface of the light-guiding layer have a depth of between 1.5 and 15 um.

6. The device of claim 1, additionally including a first cladding layer and a second cladding layer formed from a material having a lower index of refraction than the material of the light-guiding layer, wherein the light-guiding layer and the plurality of light-turning features are disposed between the first cladding layer and the second cladding layer.

7. The device of claim 1, wherein the light-guiding layer includes a thermoset plastic.

8. The device of claim 1, wherein the reflective layer includes a layer of aluminum (Al) or an aluminum-copper (Al—Cu) alloy.

9. The device of claim 1, additionally including a shielding layer on the opposite side of the reflective layer as the light-guiding layer, wherein the shielding layer is less reflective than the reflective layer.

10. The device of claim 9, wherein the shielding layer includes one of a photoresist material and a dark chrome material.

11. The device of claim 1, additionally including a reflective display disposed on the opposite side of the light-guiding layer as the plurality of light-turning features.

12. A device comprising:
a light-guiding layer capable of constraining light propagating therein, the light-guiding layer including a plurality of depressions embossed in a first surface of the light-guiding layer; and
a plurality of light-turning features disposed within the depressions in the first-surface of the light-guiding layer and including a reflective layer extending adjacent interior surfaces of the depressions without extending vertically above the edges of the depressions in the light-guiding layer.

13. The device of claim 12, wherein the light-turning features include an angled sidewall oriented at an angle to a line normal to a substantially planar section of the first surface of the light-guiding layer and capable of turning light propagating within the light-guiding layer out of the light-guiding layer.

14. The device of claim 13, wherein the angles between the sidewalls of the light-turning features and lines normal to the substantially planar portions of the first surface of the light guiding layer are between 35° and 50°.

15. The device of claim 12, wherein the plurality of light-turning features have a diameter of between 5 and 15 um at their widest point.

16. The device of claim 12, wherein the depressions in the first-surface of the light-guiding layer have a depth of between 1.5 and 15 um.

17. The device of claim 12, additionally including a first cladding layer and a second cladding layer formed from a material having a lower index of refraction than the material of the light-guiding layer, wherein the light-guiding layer and the plurality of light-turning features are disposed between the first cladding layer and the second cladding layer.

18. The device of claim 12, wherein the light-guiding layer includes a thermoset plastic.

19. The device of claim 12, wherein the reflective layer includes a layer of aluminum (Al) or an aluminum-copper (Al—Cu) alloy.

20. The device of claim 12, additionally including a shielding layer on the opposite side of the reflective layer as the light-guiding layer, wherein the shielding layer is less reflective than the reflective layer.

21. The device of claim 20, wherein the shielding layer includes one of a photoresist material and a dark chrome material.

22. The device of claim 12, additionally including a reflective display disposed on the opposite side of the light-guiding layer as the plurality of light-turning features.

23. The device of claim 22, additionally including:
a processor capable of communicating with the reflective display, the processor being capable of processing image data; and
a memory device capable of communicating with the processor.

24. The device of claim 23, additionally including:
a driver circuit capable of sending at least one signal to the reflective display; and
a controller capable of sending at least a portion of the image data to the driver circuit.

25. The device of claim 23, additionally at least one of:
an image source module capable of sending the image data to the processor, wherein the image source module includes at least one of a receiver, transceiver, and transmitter; and
an input device capable of receiving input data and to communicate the input data to the processor.

26. A device comprising:
a light-guiding layer capable of constraining light propagating therein, the light-guiding layer including a plurality of depressions embossed in a first surface of the light-guiding layer; and
a plurality of depressions embossed into the depressions in the first-surface of the light-guiding layer; and
aluminized polymer layers extending adjacent interior surfaces of the depressions to form a plurality of light-turning features within the plurality of depressions in the light-guiding layer.

27. The device of claim 26, wherein the aluminized polymer layers do not extend vertically above the edges of the depressions in the light-guiding layer.

28. The device of claim 26, wherein the aluminized polymer layers do not extend laterally beyond the edges of the depressions in the light-guiding layer and over a substantially planar portion of the first surface of the light-guiding layer.

29. The device of claim 26, wherein the light-guiding layer includes a thermoset plastic.

30. The device of claim 26, wherein each of the plurality of depressions includes an angled sidewall oriented at an angle of between 35° and 50° to a line normal to the first surface of the light-guiding layer.
